(19) United States
(12) Patent Application Publication
(10) Pub. No.: US 2025/0260071 A1
(43) Pub. Date: Aug. 14, 2025

(54) POWER STORAGE MODULE

(71) Applicant: TOYOTA JIDOSHA KABUSHIKI KAISHA, Toyota-shi (JP)

(72) Inventor: Shingo KOMURA, Nagakute-shi (JP)

(73) Assignee: TOYOTA JIDOSHA KABUSHIKI KAISHA, Toyota-shi (JP)

(21) Appl. No.: 19/043,869

(22) Filed: Feb. 3, 2025

(30) Foreign Application Priority Data
Feb. 14, 2024 (JP) 2024-020175
Dec. 2, 2024 (JP) 2024-209539

(51) Int. Cl. H01M 10/42; H01M 50/121; H01M 50/463

(52) U.S. Cl. CPC H01M 10/4235; H01M 50/121; H01M 50/463

(57) ABSTRACT

A power storage module includes a first active material layer and a second active material layer, a separator disposed between the first active material layer and the second active material layer, and a gas discharge restricting portion. The second active material layer includes a main surface positioned toward the first active material layer. The main surface includes an opposite region that is opposite the first active material layer. The gas discharge restricting portion is provided on the main surface and is provided in a position being outside the opposite region and adjoining the opposite region.

### CROSS REFERENCE TO RELATED APPLICATIONS

This nonprovisional application is based on Japanese Patent Application No. 2024-020175 filed on Feb. 14, 2024, and Japanese Patent Application No. 2024-209539 filed on Dec. 2, 2024, with the Japan Patent Office, the entire contents of which are hereby incorporated by reference.

### BACKGROUND

### Field

The present disclosure relates to a power storage module.

### Description of the Background Art

For example, Japanese Patent Laying-Open No. 2020-177761 discloses a power storage module that includes an electrode stack constituted of a plurality of unit cells and a resin material provided so as to surround a side surface of the electrode stack.

### SUMMARY

A power storage module includes a resin frame and an electrode stack disposed in the resin frame. The electrode stack includes a plurality of unit cells.

The plurality of unit cells include a first current collector plate, a first active material layer, a separator, a second active material layer, and a second current collector plate. The separator is disposed between the first active material layer and the second active material layer. In the unit cells adjoining each other in a stack direction, the first current collector plate of one of the unit cells and the second current collector plate of the other unit cell are in contact with each other, and the first current collector plate and the second current collector plate in contact with each other form a stacked current collector plate.

The power storage module is sealed with the resin frame, the first current collector plate, and the second current collector plate. An electrolyte solution is housed in the power storage module. The first active material layer, the second active material layer, and the separator are soaked in the electrolyte solution.

When the electrical insulation function of the separator is lost in the power storage module configured as described above, the first active material layer and the second active material layer that are opposite each other with the separator interposed therebetween are short-circuited and a short-circuit current is caused. The short-circuit current induces Joule heat, which heats the electrolyte solution. The electrolyte solution raised in temperature through the heating gasifies. The gas increases the internal pressure of the power storage module and causes the power storage module to expand. After that, the power storage module cannot retain the gas therein, and the gas may break the resin frame of the power storage module and burst to the outside.

The present disclosure has been made in view of the above-described problem, and an object of the present disclosure is to provide a power storage module that enables it to hinder an adverse effect due to expansion of gas caused by vaporization of an electrolyte solution raised in temperature.

A power storage module according to a first aspect of the present disclosure includes a first active material layer and a second active material layer, a separator disposed between the first active material layer and the second active material layer, and a projecting portion. The second active material layer includes a main surface positioned toward the first active material layer. The main surface includes an opposite region that is opposite the first active material layer. The projecting portion is provided on the main surface and is provided in a position being outside the opposite region and adjoining the opposite region.

In the power storage module according to the first aspect of the present disclosure, the projecting portion is provided so as to extend in an annular manner along an outer peripheral edge portion of the opposite region.

In the power storage module according to the first aspect of the present disclosure, the projecting portion has a height of 50 μm or more from the main surface.

The power storage module according to the first aspect of the present disclosure further includes a current collector plate on which the first active material layer is provided. The current collector plate is positioned opposite the separator in relation to the first active material layer. At least one groove portion is provided in the first active material layer. The current collector plate is exposed from the first active material layer in the at least one groove portion.

In the power storage module according to the first aspect of the present disclosure, the first active material layer and the second active material layer each have a dimension of at least 1 m or more in a length direction or a width direction.

In the power storage module according to the first aspect of the present disclosure, a width of the at least one groove portion is 0.5 mm or more and 20 mm or less.

In the power storage module according to the first aspect of the present disclosure, an interval of the at least one groove portion is 40 mm or more and 350 mm or less.

A power storage module according to a second aspect of the present disclosure includes a plurality of bipolar electrodes stacked in a stack direction, and a separator disposed between the plurality of bipolar electrodes. Each of the plurality of bipolar electrodes includes a current collector plate, a first active material layer, a second active material layer, and a projecting portion. The current collector plate includes a first application surface and a second application surface in the stack direction. The first active material layer is applied to the first application surface of the current collector plate. The second active material layer is applied to the second application surface of the current collector plate and includes a main surface. The main surface is covered with the separator. The main surface includes an opposite region being opposite the first active material layer included in one of the plurality of bipolar electrodes adjacent to each other with interposition of the separator. The projecting portion is provided on the main surface and is provided in a position being outside the opposite region and adjoining the opposite region.

In the power storage module according to the second aspect of the present disclosure, the projecting portion is provided so as to extend in an annular manner along an outer peripheral edge portion of the opposite region.

In the power storage module according to the second aspect of the present disclosure, at least one groove portion is provided in the first active material layer. The current collector plate is exposed from the first active material layer in the at least one groove portion.

The foregoing and other objects, features, aspects, and advantages of the present disclosure will become apparent from the following detailed description of the present disclosure, which will be understood in conjunction with the accompanying drawings.

### BRIEF DESCRIPTION OF THE DRAWINGS

FIG. 1 is a diagram schematically showing a power storage module according to an embodiment of the present disclosure.

FIG. 2 is an end surface view of the power storage module along line II-II in FIG. 1, which is seen in the arrow direction.

FIG. 3 is a diagram schematically showing a first active material layer in FIG. 2.

FIG. 4 is a table showing conditions of a comparison test and evaluation results under respective conditions.

FIG. 5 is a table showing categorization on the degree of a temperature rise.

### DESCRIPTION OF THE PREFERRED EMBODIMENTS

Embodiments of the present disclosure are described with reference to the drawings. In the drawings referred to below, the same reference numerals are given to identical or equivalent members.

### <Configuration of Power Storage Module>

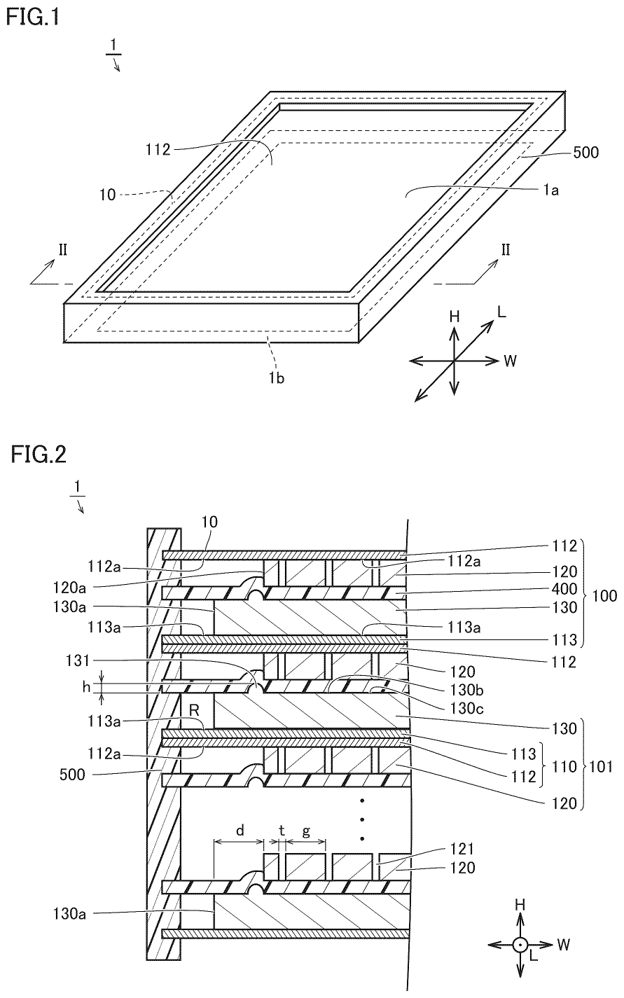

FIG. 1 is a schematic diagram of a power storage module 1 according to an embodiment of the present disclosure. In FIG. 1 and the like, a stack direction H represents a stack direction of power storage module 1. In FIG. 1, a width direction W and a length direction L represent a width direction and a length direction of power storage module 1, respectively.

As shown in FIG. 1, power storage module 1 is formed so as to have a rectangular parallelepiped shape. Power storage module 1 includes a first main surface 1a and a second main surface 1b lying at a distance from each other in stack direction H. Power storage module 1 includes an electrode stack 10 and a resin portion 500.

FIG. 2 is an end surface view of the power storage module along line II-II in FIG. 1, which is seen in the arrow direction. Electrode stack 10 includes a plurality of unit cells 100. The plurality of unit cells 100 are stacked in stack direction H.

Each unit cell 100 includes a first current collector plate 112, a first active material layer 120, a separator 400, a second active material layer 130, and a second current collector plate 113.

First active material layer 120 is, for example, a positive electrode active material layer. First active material layer 120 is formed on a first application surface 112a of first current collector plate 112. First application surface 112a is a lower surface of first current collector plate 112.

Second active material layer 130 is, for example, a negative electrode active material layer. Second active material layer 130 is formed on a second application surface 113a of second current collector plate 113. Second application surface 113a is an upper surface of second current collector plate 113.

Separator 400 is disposed between first active material layer 120 and second active material layer 130.

In unit cells 100 adjoining each other in stack direction H, first current collector plate 112 of one of unit cells 100 and second current collector plate 113 of the other unit cell 100 are in contact with each other. First current collector plate 112 and second current collector plate 113 in contact with each other form a stacked current collector plate 110.

Although an example in which first current collector plate 112 and second current collector plate 113 are in contact with each other is shown, the present disclosure is not limited thereto. First current collector plate 112 and second current collector plate 113 are just required to be at least electrically connected to each other. For example, first current collector plate 112 and second current collector plate 113 may be electrically connected to each other by being stacked with interposition of a conductive adhesive, a conductive material, a conductive resin, or a combination of these. The first current collector plate and the second current collector plate may be electrically connected to each other via a conductive wire or a terminal.

Stacked current collector plate 110 is formed so as to have a rectangular shape when stacked current collector plate 110 is seen in a plan view from a position at a distance from stacked current collector plate 110 in stack direction H. Stacked current collector plate 110 includes first current collector plate 112 and second current collector plate 113. First current collector plate 112 is made of aluminum for example. Second current collector plate 113 is made of copper for example. In stack direction H, stacked current collector plate 110 includes first application surface 112a, which is a surface of first current collector plate 112, and second application surface 113a, which is a surface of second current collector plate 113.

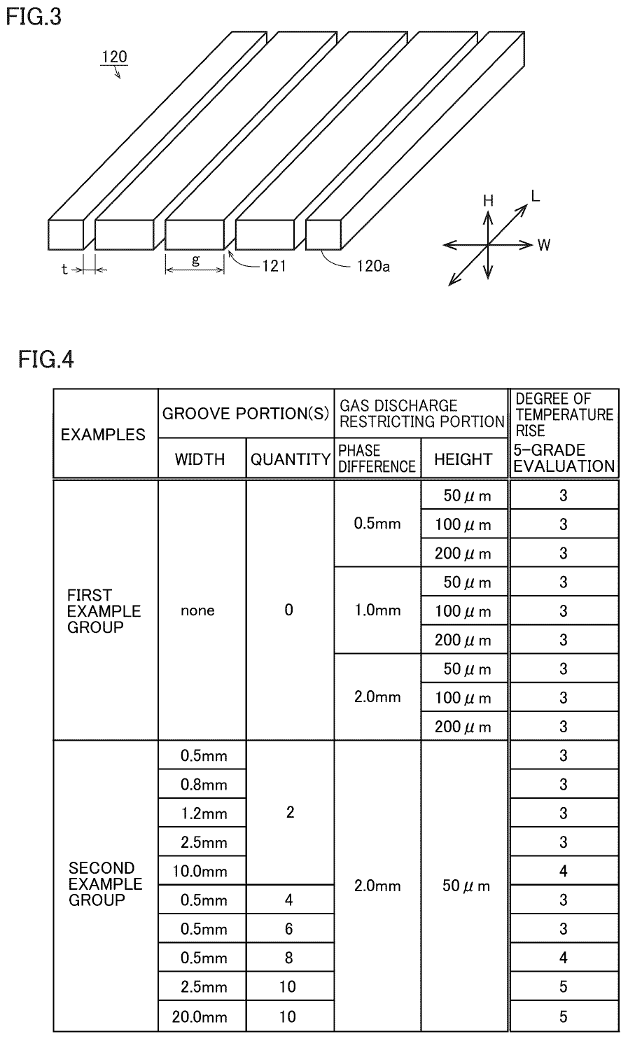

FIG. 3 is a diagram schematically showing first active material layer 120. For example, first active material layer 120 is formed so as to have a rectangular shape when first active material layer 120 is seen in a plan view from a position at a distance from first active material layer 120 in stack direction H. First active material layer 120 is formed so that its dimension in length direction L or width direction W is at least 1.0 m or more. At least one groove portion 121 is formed in first active material layer 120.

Groove portion 121 is formed so as to extend in length direction L. Both ends of groove portion 121 reach an outer peripheral edge portion 120a of first active material layer 120 and first active material layer 120 is partitioned into a plurality of portions by the plurality of groove portions 121. A groove width t of groove portion 121 is, for example, 0.5 mm or more and, for example, 20.0 mm or less. Groove portions 121 and their respective adjacent groove portions 121 are arranged at intervals g in width direction W. Interval g is, for example, 40 mm or more and, for example, 350 mm or less.

Referring again to FIG. 2, in groove portion 121, first application surface 112a of first current collector plate 112 is exposed from first active material layer 120.

For example, when second active material layer 130 is seen in a plan view from a position at a distance from second active material layer 130 in stack direction H, second active material layer 130 is formed so as to have a rectangular shape, and further, is formed so as to protrude from first active material layer 120. Specifically, an outer peripheral edge portion 130a of second active material layer 130 protrudes outward by a phase difference d from outer peripheral edge portion 120a of first active material layer 120. Phase difference d is, for example, 0.5 mm or more. Second active material layer 130 is formed so that its dimension in length direction L or width direction W is at least 1.0 m or more.

In unit cell 100, second active material layer 130 includes a main surface 130b positioned toward first active material layer 120.

Main surface 130b includes an opposite region 130c being a region that is opposite first active material layer 120. When second active material layer 130 and first active material layer 120 are seen in a plan view from a position at a distance in stack direction H, outer peripheral edge portion 120a is positioned inside outer peripheral edge portion 130a. Thus, opposite region 130c is part of main surface 130b.

Second active material layer 130 includes a gas discharge restricting portion 131. Gas discharge restricting portion 131 is a projecting portion formed integrally with second active material layer 130. Gas discharge restricting portion 131 is provided on main surface 130b. More specifically, gas discharge restricting portion 131 is formed in a position being outside opposite region 130c and adjoining opposite region 130c. Gas discharge restricting portion 131 is formed so as to extend in an annular manner along an outer peripheral edge portion of opposite region 130c. Gas discharge restricting portion 131 is formed so as to project from main surface 130b by a height h. Height h is 50 μm or more. The cross-sectional shape of gas discharge restricting portion 131 is semicircular but may be rectangular, trapezoidal, or elliptical.

Gas discharge restricting portion 131 is an example of the projecting portion according to the present disclosure.

Separator 400 is formed so as to have a rectangular shape when seen from a position at a distance from separator 400 in stack direction H. Separator 400 is formed so as to protrude from outer peripheral edge portion 130a.

Separator 400 is formed like a sheet for example. Separator 400 may be a porous sheet or a nonwoven fabric. For example, separator 400 contains polymer that absorbs and retains an electrolyte. Examples of the material from which separator 400 is formed include polypropylene (PP), polyethylene (PE), polyolefin, and polyester.

Separator 400 may have a single-layer structure or a multilayer structure. For example, in order to enhance heat resistance and electrical insulation properties, a multilayer structure constituted of a porous resin layer and a ceramic layer may be employed as separator 400.

A resin portion 500 is formed in an annular manner so as to surround electrode stack 10. An outer peripheral end portion of stacked current collector plate 110 and an outer peripheral end portion of separator 400 are embedded in resin portion 500. Resin portion 500 and stacked current collector plate 110 embedded in resin portion 500 form a space R, which is sealed. An electrolyte solution is provided in space R sealed.

In both end portions of power storage module 1 in stack direction H, first current collector plate 112 and second current collector plate 113 are exposed. By disposing a member with conductivity (such as a current collector plate) on the portion exposed, it is enabled to electrically connect a plurality of power storage modules 1 in series.

The configuration of power storage module 1 is described above, focusing on unit cell 100. On the other hand, power storage module 1 is a bipolar battery and includes a plurality of bipolar electrodes 101. The details are described below.

Power storage module 1 includes the plurality of bipolar electrodes 101, which are stacked in stack direction H, and separator 400. Separator 400 is disposed between bipolar electrodes 101.

Bipolar electrode 101 includes second active material layer 130, stacked current collector plate 110, and first active material layer 120. Stacked current collector plate 110 includes first current collector plate 112 and second current collector plate 113. Stacked current collector plate 110 includes first application surface 112a and second application surface 113a. First application surface 112a and second application surface 113a lie at a distance from each other in stack direction H. Second active material layer 130 is applied to second application surface 113a. First active material layer 120 is applied to first application surface 112a. Thus, stacked current collector plate 110 is positioned opposite separator 400 in relation to first active material layer 120.

Second active material layer 130 includes main surface 130b. In bipolar electrode 101, main surface 130b is a surface of second active material layer 130 and is covered with separator 400. Main surface 130b includes opposite region 130c.

In bipolar electrode 101, opposite region 130c is a region that is opposite first active material layer 120 of bipolar electrode 101 adjacent in stack direction H with separator 400 interposed therebetween.

### <Comparison Test>

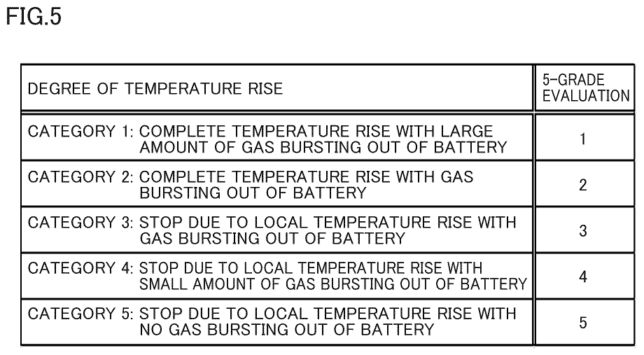

FIG. 4 is a table showing conditions for each power storage module to undergo a comparison test and evaluation results on the degree of a temperature rise in each power storage module. FIG. 5 is a table showing categorization on the degree of the temperature rise. Referring to FIGS. 4 and 5, the comparison test is described.

In the comparison test, power storage modules according to a first example group and a second example group, shown in FIG. 4, were prepared. Whether gas discharge restricting portion 131 and groove portion 121 each have an effect of inhibiting a temperature rise was confirmed by comparing, in terms of the degree of the temperature rise, the respective evaluations of the power storage modules according to the first example group and the second example group and the evaluation of the power storage module according to the comparative reference, which is not shown in FIG. 4. Unless otherwise specified, the power storage module according to the comparative reference, the power storage modules according to the first example group, and the power storage modules according to the second example group have common configurations and each had a configuration identical to that of power storage module 1 according to the embodiment of the present disclosure.

The common configurations among the power storage modules are described in detail. Each power storage module included 30 unit cells 100, and had an outer shape of 1535 mm in length direction L and 1210 mm in width direction W.

Unique configurations of the power storage modules are described.

First active material layer 120 and second active material layer 130 of the power storage module according to the comparative reference were not provided with groove portion 121 and gas discharge restricting portion 131, respectively.

In first active material layer 120 of the power storage module according to the first example group, groove portion 121 was not formed. On the other hand, there were nine types of second active material layer 130 of the power storage module according to the first example group. Specifically, second active material layer 130 had phase difference d of 0.5 mm, 1.0 mm, or 2.0 mm and included gas discharge restricting portion 131 with height h of 50 μm, 100 μm, or 200 μm.

The power storage module according to the second example group included second active material layer 130 having phase difference d of 2.0 mm and including gas discharge restricting portion 131 with height h of 50 μm. There were ten types of first active material layer 120 of the power storage module according to the second example group. Specifically, firstly, in first active material layer 120, two groove portions 121 were formed, which each had groove width t of 0.5 mm, 0.8 mm, 1.2 mm, 2.5 mm, or 10.0 mm. Secondly, in first active material layer 120, four, six, or eight groove portions 121 were formed, which each had groove width t of 0.5 mm. Thirdly, in first active material layer 120, ten groove portions 121 were formed, which each had groove width t of 2.5 mm or 20.0 mm.

The power storage module according to the comparative reference, the power storage modules according to the first example group, and the power storage modules according to the second example group were each evaluated through the comparison test in terms of the degree of the temperature rise. A specific method of the comparison test is described. First, first main surface 1a of the power storage module was heated with a heater, and the heating was ended when the temperature of second main surface 1b of the power storage module reached 300° C. After the end of the heating, how self-heating of the power storage module due to the temperature rise stopped and the inside of the power storage module after the stop of the self-heating were observed. From the observation results, the degree of the temperature rise of each power storage module was evaluated on a scale of one to five.

FIG. 5 shows the categorization on the degree of the temperature rise. As shown in FIG. 5, the degree of the temperature rise was put into one of five categories: Category 1, which indicates a complete temperature rise with a large amount of gas bursting out of the battery; Category 2, which indicates a complete temperature rise with gas bursting out of the battery; Category 3, which indicates stop due to a local temperature rise with gas bursting out of the battery; Category 4, which indicates stop due to a local temperature rise with a small amount of gas bursting out of the battery; and Category 5, which indicates stop due to a local temperature rise with no gas bursting out of the battery. The complete temperature rise relating to the degree of the temperature rise means that all of the cells in the power storage module reached a high temperature. The local temperature rise means that only part of the cells in the power storage module reached a high temperature.

In addition, each category was evaluated on a scale of one to five, and Grade 1 was given when the degree of the temperature rise was the highest and the evaluation was the lowest while Grade 5 was given when the degree of the temperature rise was the lowest and the evaluation was the highest. Categories 1 to 5 were evaluated as Grades 1 to 5, respectively.

After evaluating each power storage module in terms of the degree of the temperature rise, the evaluation of the power storage module according to the comparative reference, the evaluation of each power storage module according to the first example group, and the evaluation of each power storage module according to the second example group were compared in terms of the degree of the temperature rise. The configuration of the power storage module that gained an evaluation higher than the evaluation of the power storage module according to the comparative reference in terms of the degree of the temperature rise was determined as a configuration in which the effect of inhibiting a temperature rise was obtained.

The results of the comparison test are described below. First, the evaluation results on the degree of the temperature rise of each power storage module are described with reference to FIG. 4.

The present inventor found that when the power storage module according to the comparative reference was heated by the heating method described above, a large amount of gas burst out of the power storage module and a complete temperature rise was caused. Thus, the power storage module according to the comparative reference was evaluated as Grade 1 in terms of the degree of the temperature rise.

The power storage modules according to the first example group were all evaluated as Grade 3 in terms of the degree of the temperature rise.

The power storage modules according to the second example group were each evaluated as one of Grades 3 to 5 in terms of the degree of the temperature rise. More specifically, the power storage module including first active material layer 120 in which two groove portions 121 each having groove width t of 10.0 mm were formed was evaluated as Grade 4 in terms of the degree of the temperature rise. Further, the power storage module including first active material layer 120 in which eight groove portions 121 each having groove width t of 0.5 mm were formed was evaluated as Grade 4 in terms of the degree of the temperature rise. Moreover, the power storage module according to the second example group including first active material layer 120 in which ten groove portions 121 each having groove width t of 2.5 mm or 20.0 mm were formed was evaluated as Grade 5 in terms of the degree of the temperature rise. The other power storage modules according to the second example group were each evaluated as Grade 3 in terms of the degree of the temperature rise.

Next, the results of comparing the respective evaluations of the power storage modules in terms of the degree of the temperature rise are described.

Firstly, the evaluation of the power storage module according to the comparative reference and the respective evaluations of the power storage modules according to the first example group were compared in terms of the degree of the temperature rise.

As a result, all of the power storage modules according to the first example group were each evaluated as a grade higher than that of the power storage module according to the comparative reference in terms of the degree of the temperature rise. Accordingly, it could be confirmed that the effect of inhibiting a temperature rise was obtained by causing gas discharge restricting portion 131 formed so as to extend in an annular manner to adjoin opposite region 130c of second active material layer 130.

Secondly, the respective evaluations of the power storage modules in the first example group were mutually compared in terms of the degree of the temperature rise.

As a result, all of the power storage modules according to the first example group were each evaluated as the same grade in terms of the degree of the temperature rise. Accordingly, it could be confirmed that the effect of inhibiting a temperature rise brought by forming gas discharge restricting portion 131 on second active material layer 130 was the same within the range of a combination of phase difference d and height h of gas discharge restricting portion 131 shown as to the first example group in FIG. 4.

Thirdly, the evaluation of the power storage module according to the comparative reference and the respective evaluations of the power storage modules according to the second example group were compared in terms of the degree of the temperature rise.

As a result, all of the power storage modules according to the second example group were each evaluated as a grade higher than that of the power storage module according to the comparative reference in terms of the degree of the temperature rise. Accordingly, it was confirmed that the effect of inhibiting a temperature rise was obtained by forming groove portion 121 in first active material layer 120 and forming gas discharge restricting portion 131 on second active material layer 130.

Fourthly, the respective evaluations of the power storage modules according to the first example group and the respective evaluations of the power storage modules according to the second example group were compared in terms of the degree of the temperature rise. More specifically, comparison was performed between the power storage module according to the first example group including second active material layer 130 on which gas discharge restricting portion 131 having phase difference d of 2.0 mm and height h of 50 μm was formed, and the power storage modules according to the second example group each including second active material layer 130 on which gas discharge restricting portion 131 having phase difference d of 2.0 mm and height h of 50 μm was formed and including first active material layer 120 in which groove portions 121 each having groove width t of 0.5 mm were formed.

As a result, in terms of the degree of the temperature rise, each power storage module including first active material layer 120 in which no groove portion 121 was formed was evaluated as the same grade as that of the power storage module including first active material layer 120 in which two, four, or six groove portions 121 each having groove width t of 0.5 mm were formed.

On the other hand, in terms of the degree of the temperature rise, the power storage module including first active material layer 120 in which eight groove portions 121 each having groove width t of 0.5 mm were formed was evaluated as a grade higher than that of the power storage module including first active material layer 120 in which six groove portions 121 each having groove width t of 0.5 mm were formed.

Accordingly, it was confirmed that first active material layer 120 in which a predetermined quantity of groove portions were formed had a higher effect of inhibiting a temperature rise in comparison with first active material layer 120 in which no groove portion 121 was formed. Here, the predetermined quantity denotes the number of groove portions 121 that is eight or more, groove portions 121 each having groove width t of 0.5 mm.

Fifthly, the respective evaluations of the power storage modules in the second example group were mutually compared in terms of the degree of the temperature rise.

As a result, in terms of the degree of the temperature rise, the power storage module including first active material layer 120 in which two groove portions 121 each having groove width t of 10.0 mm were formed was evaluated as a grade higher than that of the power storage module including first active material layer 120 in which two groove portions 121 each having groove width t of 2.5 mm were formed. Accordingly, it was confirmed that by widening groove width t, a higher effect of inhibiting a temperature rise was obtained.

On the other hand, in terms of the degree of the temperature rise, the power storage module in which ten groove portions 121 each having groove width t of 20.0 mm were formed was evaluated as the same grade as that of the power storage module in which ten groove portions 121 each having groove width t of 2.5 mm were formed. Accordingly, it was confirmed that the effect of inhibiting a temperature rise by widening groove width t was limited.

Sixthly, in terms of the degree of the temperature rise, the evaluation of the power storage module according to the comparative reference, the respective evaluations of the power storage modules according to the first example group, and the respective evaluations of the power storage modules according to the second example group were compared.

As a result, the power storage module according to the second example group including first active material layer 120 in which ten groove portions 121 each having groove width t of 2.5 mm or 20.0 mm were formed was evaluated as the highest grade in terms of the degree of the temperature rise. Accordingly, it was confirmed that within the range of the test conditions of this comparison test, the power storage module including second active material layer 130 on which gas discharge restricting portion 131 having phase difference d of 2.0 mm and height h of 50 μm was formed and first active material layer 120 in which ten groove portions 121 each having groove width t of 2.5 mm or 20.0 mm were formed had the highest effect of inhibiting a temperature rise under the conditions of this test. In view of reservation of an application area for first active material layer 120, it may be determined that the most preferable condition was presented by the power storage module including second active material layer 130 on which gas discharge restricting portion 131 having phase difference d of 2.0 mm and height h of 50 μm was formed and first active material layer 120 in which ten groove portions 121 each having groove width t of 2.5 mm were formed.

In this test, the effect of inhibiting a temperature rise was obtained when interval g was 40 mm or more and 350 mm or less.

In the embodiment of the present disclosure, separator 400 is, for example, a porous body formed of a porous sheet. Gas discharge restricting portion 131 is formed so as to adjoin opposite region 130c. Because of such a configuration, separator 400 follows the shape of gas discharge restricting portion 131 and a bent portion is formed in separator 400.

The first active material layer and the second active material layer are short-circuited and a short-circuit current is caused. The electrolyte solution is raised in temperature by Joule heat induced by the short-circuit current and gasifies, and the volume thereof expands and accordingly, a slight space is formed between the first active material layer and the second active material layer. The gas moves in the space in the horizontal direction. The projecting portion serves as a physical barrier against the gas moving in the horizontal direction and can inhibit discharge of the gas to the outside of the gas discharge restricting portion.

Thus, it is enabled to inhibit increase in the internal pressure of space R and inhibit a partial rupture of resin portion 500. If resin portion 500 partially ruptures, stacked current collector plates 110 adjacent to each other in stack direction H may come into contact with each other and a short circuit may be caused.

In contrast, in power storage module 1 according to the embodiment of the present disclosure, it is enabled to inhibit a rupture of resin portion 500 as described above and thus, occurrence of the above-described adverse effect can be hindered.

In the embodiment of the present disclosure, groove portion 121 is formed in first active material layer 120. With such a configuration, the gas caused by vaporization of the electrolyte solution in separator 400 climbs through groove portion 121 and reaches stacked current collector plate 110. The gas that has reached stacked current collector plate 110 dissipates heat to stacked current collector plate 110, and the gas temperature is lowered accordingly. Thus, by lowering the gas temperature, melting of separator 400 can be hindered and short-circuiting of first active material layer 120 and second active material layer 130 can be inhibited. As the gas temperature is lowered, the volume of the gas decreases and the pressure in space R can be reduced.

In particular, in bipolar electrode 101 including stacked current collector plate 110 in which first current collector plate 112 and second current collector plate 113 are formed in direct contact with each other, the heat of the gas that has reached the current collector plate through groove portion 121 is dissipated through the current collector plate more easily in comparison with a battery in which first current collector plate 112 and second current collector plate 113 are electrically connected to each other via a conductive wire, a terminal, or the like. Accordingly, the temperature of the gas is lowered, the volume of the gas decreases, and the pressure in space R can be further reduced.

Although the above-described embodiment shows an example in which gas discharge restricting portion 131 is formed integrally with second active material layer 130, the present disclosure is not limited thereto. For example, gas discharge restricting portion 131 may be formed separately from second active material layer 130 and may be disposed in a position being outside opposite region 130c in main surface 130b and adjoining opposite region 130c.

Gas discharge restricting portion 131 may be formed of a material different from that of second active material layer 130. For example, gas discharge restricting portion 131 may be formed by shaping a resin or the like in an annular manner on main surface 130b along the outer periphery of opposite region 130c.

Although the above-described embodiment shows an example in which groove portion 121 is formed so as to extend in length direction L, the present disclosure is not limited thereto. For example, when seen in stack direction H, groove portions 121 may be formed in a lattice manner or be partially formed. Groove portion 121 is not necessarily required to be linear.

Although embodiments of the present disclosure have been described, it should be understood that the herein-disclosed embodiments are presented by way of illustration and example in all respects and are not to be taken by way of limitation. The scope of the present disclosure is defined by the claims and intended to include all changes within the purport and scope equivalent to the claims.

What is claimed is:

1. A power storage module comprising:
a first active material layer and a second active material layer;
a separator disposed between the first active material layer and the second active material layer; and
a projecting portion, wherein
the second active material layer includes a main surface positioned toward the first active material layer,
the main surface includes an opposite region that is opposite the first active material layer, and
the projecting portion is provided on the main surface and is provided in a position being outside the opposite region and adjoining the opposite region.

2. The power storage module according to claim 1, wherein the projecting portion is provided so as to extend in an annular manner along an outer peripheral edge portion of the opposite region.

3. The power storage module according to claim 1, wherein the projecting portion has a height of 50 μm or more from the main surface.

4. The power storage module according to claim 1, further comprising
a current collector plate on which the first active material layer is provided, wherein
the current collector plate is positioned opposite the separator in relation to the first active material layer,
at least one groove portion is provided in the first active material layer, and
the current collector plate is exposed from the first active material layer in the at least one groove portion.

5. The power storage module according to claim 4, wherein the first active material layer and the second active material layer each have a dimension of at least 1 m or more in a length direction or a width direction.

6. The power storage module according to claim 4, wherein a width of the at least one groove portion is 0.5 mm or more and 20 mm or less.

7. The power storage module according to claim 4, wherein an interval of the at least one groove portion is 40 mm or more and 350 mm or less.

8. A power storage module comprising:
a plurality of bipolar electrodes stacked in a stack direction; and
a separator disposed between the plurality of bipolar electrodes, wherein
each of the plurality of bipolar electrodes includes a current collector plate, a first active material layer, a second active material layer, and a projecting portion,
the current collector plate includes a first application surface and a second application surface in the stack direction,
the first active material layer is applied to the first application surface of the current collector plate,
the second active material layer is applied to the second application surface of the current collector plate and includes a main surface,
the main surface is covered with the separator,
the main surface includes an opposite region being opposite the first active material layer included in one of the plurality of bipolar electrodes adjacent to each other with interposition of the separator, and
the projecting portion is provided on the main surface and is provided in a position being outside the opposite region and adjoining the opposite region.

9. The power storage module according to claim 8, wherein the projecting portion is provided so as to extend in an annular manner along an outer peripheral edge portion of the opposite region.

10. The power storage module according to claim 8, wherein
at least one groove portion is provided in the first active material layer, and
the current collector plate is exposed from the first active material layer in the at least one groove portion.
